(19) United States
(12) Patent Application Publication
(10) Pub. No.: US 2004/0234081 A1
(43) Pub. Date: Nov. 25, 2004

(54) Automobile audio system

(76) Inventors: Robert J. Brice, Eugene, OR (US); Steve K. Chin, Eugene, OR (US)

Correspondence Address: KOLISCH HARTWELL, P.C., 520 S.W. YAMHILL STREET, SUITE 200, PORTLAND, OR, 97204, US

(21) Appl. No.: 10/385,934

(22) Filed: Feb. 6, 2003

Related U.S. Application Data
(63) Continuation of application No. 09/902,867, filed on Jul. 10, 2001, now abandoned.

(51) Int. Cl. H04B 1/00; H04B 1/034; H04M 9/08

(52) U.S. Cl. 381/86; 455/99; 381/2

(57) ABSTRACT

An automobile audio system, including a transmitter configured for installation within an automobile and further configured to wirelessly transmit modulated carrier data associated with at least two audio signals so that the modulated carrier data is receivable within the automobile. The automobile audio system may also include a receiver configured for use within the automobile, where the receiver is selectively tunable to obtain a recovered audio signal from the modulated carrier data and output the recovered audio signal, the recovered audio signal being an at least approximate reproduction of a user-desired one of the audio signals.

### CROSS-REFERENCE TO RELATED APPLICATIONS

This application is a continuation of U.S. patent application Ser. No. 09/902,867, filed Jul. 10, 2001 and entitled “Automobile Audio System”.

### FIELD OF THE INVENTION

The present invention relates to automobile audio systems, and particularly to an automobile audio system configured to wirelessly transmit, within an automobile, data associated with two or more audio signals so that the audio signals may be selectively recovered from the transmitted data.

### BACKGROUND OF THE INVENTION

Conventional automobile audio systems typically require that all occupants of the vehicle listen to the same audio source. For example, when a conventional dashboard-installed stereo unit is tuned to a particular radio station, everyone in the automobile must listen to that same radio station. When a particular compact disc is played, everyone must listen to that same disc, etc. This results from conventional speaker/output configurations, in which output from only one audio source (e.g., an AM/FM radio, audiocassette player, compact disc player, etc.) is provided at a given time, and in which the output is delivered by a single speaker system to the entire driver/passenger compartment of the automobile.

This problem occurs even though automobiles typically have many different source devices capable of providing audio output. For example, a single automobile might be outfitted with a DVD player, a videocassette player, and a conventional car stereo with AM/FM radio, cassette, compact disc, etc. The automobile might also include systems for providing occupants with audio messages relating to safety or operation of the automobile, for example, a pre-recorded reminder to fasten safety belts. Although a number of audio source devices may be installed in the automobile, typically only one source device output is active at a given time. As a result, with most automobile audio systems, the driver would not be able to listen the AM/FM radio while a backseat passenger listened to audio output from the DVD player. Where this is possible, for example as a result of separate speaker systems, simultaneous output from the two sources would create a noisy disturbance interfering with the ability of each occupant to hear his or her desired audio source. Interference may be reduced or eliminated through use of headphones, though the cabling associated with conventional headphones limits freedom of movement and is otherwise inconvenient.

### SUMMARY OF THE INVENTION

The invention provides an improved automobile audio system having a transmitter that is configured for installation within an automobile and adapted to wirelessly transmit modulated carrier data so that the modulated carrier data is receivable within the automobile. The modulated carrier data is associated with at least two audio signals which are used to generate the modulated carrier data. The transmitter is configured to transmit the modulated carrier data so as to permit it to be selectively processed within the automobile, thereby allowing a desired one of the audio signals to be recovered from the modulated carrier data.

The automobile audio system may further include a receiver configured for use within the automobile. The receiver is selectively tunable to obtain from the modulated carrier data a recovered audio signal, which is an at least approximate reproduction of a user-desired one of the audio signals. Multiple receivers may be used, allowing different occupants of the automobile to listen to different audio signals recovered from the modulated carrier data.

### BRIEF DESCRIPTION OF THE FIGURES

FIG. 1 is a schematic view of an automobile audio system according to the present invention, including various audio source devices and a transmitter configured to wirelessly communicate data to one or more receivers based on output of the audio source devices.

FIG. 2 is a schematic view of depicting additional embodiments of a transmitter and receiver according to the present invention.

FIG. 3 is an isometric view of a headphone unit that may be used in connection with a receiver according to the present invention.

FIG. 4 is a schematic view depicting further embodiments of a transmitter and receiver according to the present invention.

FIG. 5 is a schematic view depicting still further embodiments of a transmitter and receiver according to the present invention.

FIG. 6 is a flowchart depicting a method according to the present invention for delivering audio to different occupants of an automobile so that they can simultaneously and selectively listen to audio output from different audio source devices provided within the automobile.

### DETAILED DESCRIPTION OF THE INVENTION

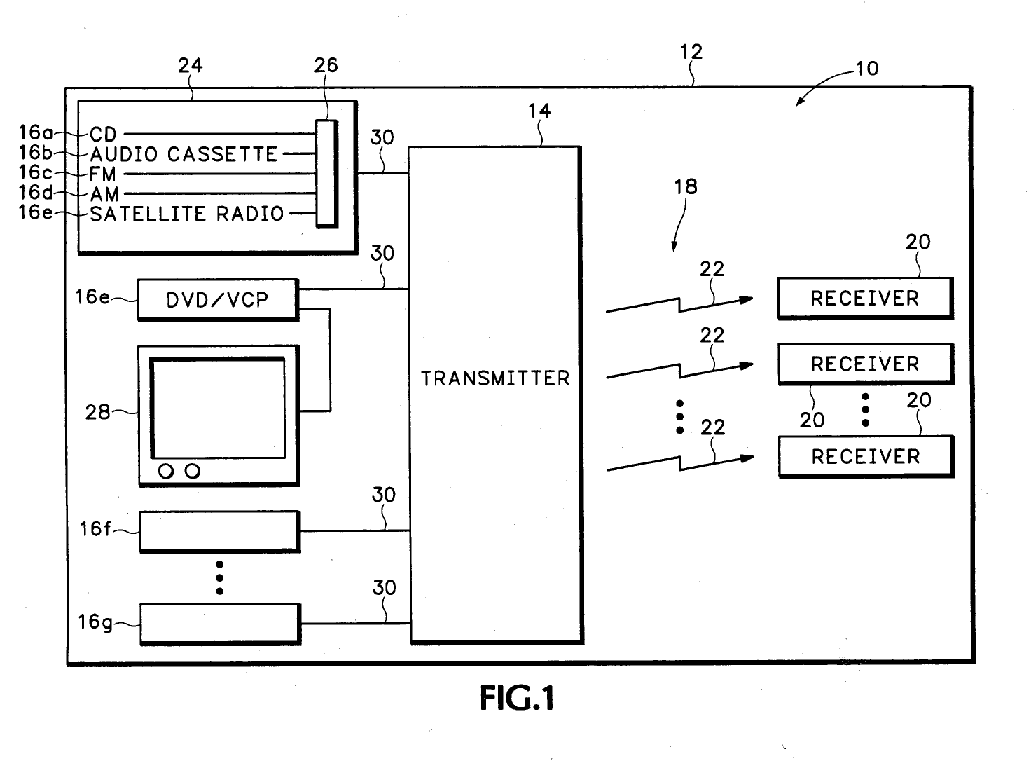

FIG. 1 schematically depicts an automobile audio system 10 according to the present invention, as installed within the driver/passenger compartment of automobile 12. Automobile audio system 10 includes a transmitter 14 provided within automobile 12 and coupled with one or more audio source devices 16 located in the automobile. Consistent with a convention that will be used in connection with various of the other drawing figures, audio source devices 16 will generally be referred to with designator 16 and specifically designated as 16a, 16b, etc. Based on output received from one or more of audio source devices 16, transmitter 14 wirelessly transmits modulated carrier data 18 so that it is receivable within automobile 12 by one or more receivers 20. Typically, modulated carrier data 18 includes one or more modulated carrier signals 22 that are generated using audio signals outputted by audio source devices 16. Each receiver 20 is selectively tunable, allowing an operator to cause the receiver to process modulated carrier data 18 so as to obtain from the modulated carrier data a recovered audio signal, which is based on a particular desired audio signal produced by one of audio source devices 16.

For the sake of simplicity, the audio signal produced by a particular source device 16 and the corresponding signal recovered by receiver 20 will often be referred to as “the audio signal,” without distinguishing between the source device output and the recovered signal. However, it should be understood that, in many cases, the signal recovered at the receiver is only an approximate, as opposed to identical, reproduction of the original signal produced by the audio source device. This may occur, for example, within certain modulation techniques.

When used in an automobile, automobile audio system 10 provides a number of advantages, regardless of whether one receiver or multiple receivers are used. Use of a single receiver 20 allows the operator of that receiver to select from and listen to a number of available audio signals provided by audio source devices 16. In addition, the selection among audio signals may be made independent of any selection operation performed on or at source devices 16, and may be made without affecting the operation of the audio source devices. As will be later explained, the present invention provides for incorporation of a receiver, such as one of receivers 20, with a pair of wireless headphones. The operational independence of the receiver from the source devices allows such a headphone receiver unit to be tuned from the backseat of the automobile, or from other locations where it would be difficult or inconvenient to access the audio source devices. Typically, tuning the headphone receiver unit will not affect the operation of any of the source devices. Instead, tuning simply changes how the receiver receives and/or processes modulated carrier data 18 broadcast by transmitter 14.

Use of an additional receiver or receivers provides further advantages. Typically, the various receivers are independent from each other, in addition to being independent from transmitter 14. Thus, one receiver 20 can recover audio from a first one of audio source devices 16, while a second receiver 20 recovers audio from a different one of the audio source devices. Accordingly, unlike with a conventional automobile audio system, different occupants may listen to output from different audio source devices that are installed in the automobile, simultaneously and without disturbing each other. For example, referring still to FIG. 1, one occupant can listen to CD player 16a while another listens to the audio output from video player 16e.

As indicated in FIG. 1, audio source devices 16 may include a CD player 16a, audiocassette player 16b, FM radio 16c, AM radio 16d and satellite radio 16e, all of which are provided as part of automobile stereo system 24, which is of a type commonly installed into automobile dashboards. Automobile stereo system 24 includes a selector 26, which may be operated to provide an output audio signal from a desired one of the audio source devices included with system 24. Instead of, or in addition to the depicted configuration, automobile stereo system 24 may include an output line for each of its audio source devices. As seen in the figure, automobile 12 may also be provided with a video player, such as a digital video disc (DVD) player or videocassette (VCP) player 16e, and an accompanying video monitor 28. In addition to providing video output, DVD/VCP 16e produces audio output, and may thus be thought of as another audio source device 16, similar to CD player 16a, audiocassette player 16b, etc. Various other audio source devices 16f 16g, etc. may be provided within automobile 12 and coupled with transmitter 14. Indeed, the automobile audio system of the present invention may be implemented with any desired number of audio source devices.

Audio source devices 16 typically are coupled with transmitter 14 via a wired connection such as output lines 30, through which output audio signals from audio source devices 16 are provided to the transmitter. As used herein, the term “audio signal” will normally mean a complete audio signal that a user of the automobile audio system would want to listen to, and thus will not refer to partial audio signals, channels or other individual components of an audio signal. For example, for a CD player or other source device producing stereo output, “audio signal” refers collectively to both the left and right channels of the stereo audio signal. Consistent with this usage, the individual left and right channels are not audio signals, but rather are “signal components,” “channels” or “partial audio signals.” On the other hand, a mono (non-stereo) signal does not have left and right channels and thus, by itself, is an audio signal.

As indicated above, transmitter 14 receives the various audio signals output by audio source devices 16 via output lines 30. The received audio signals may be used to modulate unmodulated carrier signals, which typically have frequencies that are significantly higher than the baseband range of frequencies in the audio signals. A wide variety of modulation techniques may be used to generate modulated carrier data 18, though spectra-shifting modulation methods typically are used, in which the output signal (i.e., the modulated carrier signal) is in a different, and typically higher, frequency band than the base frequency band of the modulating information signal (i.e., the audio signal).

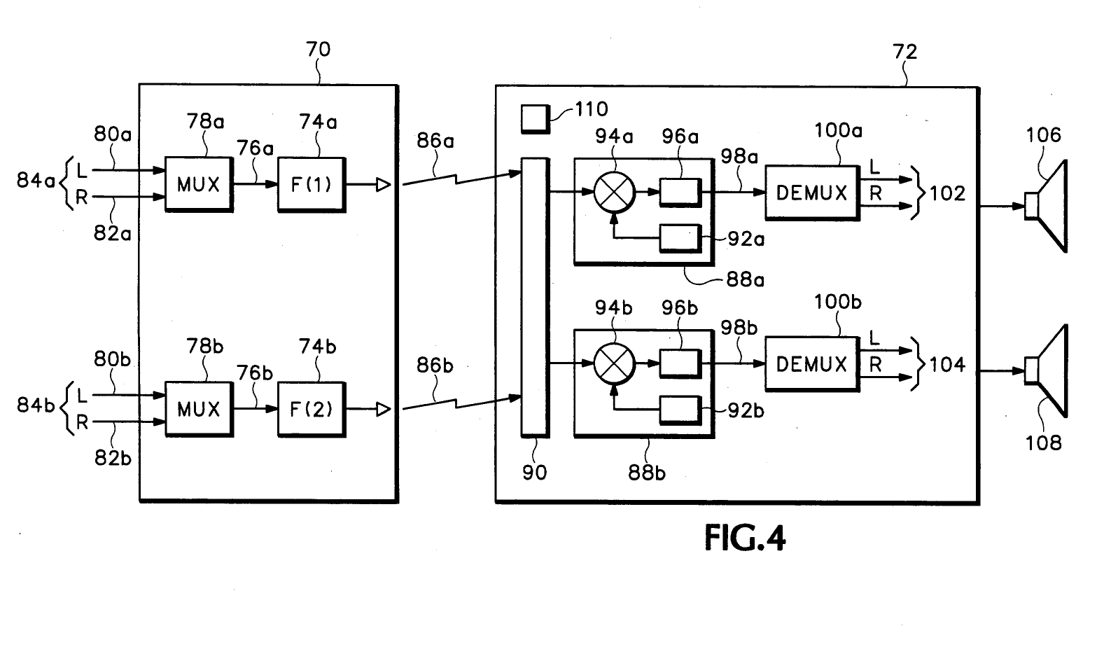

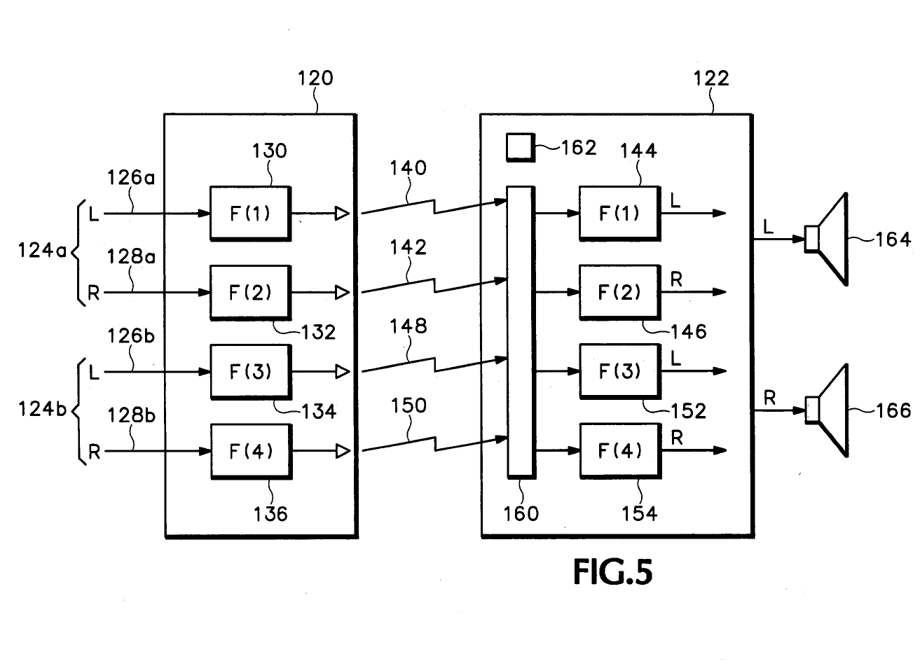

Regardless of the modulation technique used, transmitter 14 outputs modulated carrier data 18, which typically includes a number of modulated carrier signals 22. Although modulated carrier data 18 may correspond to only a single audio signal produced by audio source devices 16, transmitter 14 is configured to transmit modulated carrier data which corresponds to multiple audio signals. The transmitter and receiver embodiments shown in FIGS. 4 and 5, to be explained later, provide examples of devices configured to transmit and receiver modulated carrier data corresponding to two stereo audio signals. As indicated, the system depicted in FIG. 1 may be configured for use with 3, 4 or even more audio source devices, and is adapted to wirelessly transmit, receive and process modulated carrier data based on audio signals from each of the source devices.

“Correspondence” will often be used herein to refer to the relationship between an audio signal or signals and the modulated carrier data used to wirelessly transmit those audio signals. In many cases, this term will denote a one-to-one relationship between an audio signal and the modulated carrier signal(s) used to wirelessly transmit information relating to the audio signal. For example, if a mono audio signal is used to generate a single modulated carrier signal, then the mono input signal corresponds to the modulated carrier signal, and vice versa. Taking another example, if the left and right channels of a stereo audio signal are used separately to generate two different modulated carrier signals, then the two modulated carrier signals, when considered collectively, are in a one-to-one relationship with the stereo audio signal. Therefore, the modulated carrier signal pair corresponds to the stereo audio signal, and vice versa. The modulated carrier signals of the signal pair, when taken individually, do not correspond to the stereo audio signal as a whole, but rather only to the respective left and right channels of the stereo audio signal.

Referring specifically to FIG. 1, if the topmost modulated carrier signal 22 is the only one of the modulated carrier signals which carries information relating to the audio output from DVD/VCP player 16e, then it is the only one of the modulated carrier signals that corresponds to the DVD/VCP audio signal. If, on the other hand, the top two of modulated carrier signals 22 each carry information relating to the audio signal output from DVD/VCP player 16e (e.g., left and right channels of the stereo output), then that pair of modulated carrier signals corresponds to the DVD/VCP stereo audio signal.

From the above, it should be understood that a single audio signal may include various components or channels that are separately transmitted via different modulated carrier signals. This commonly occurs in the above-discussed example of a stereo audio signal transmitted via two separate modulated carrier signals: one for each of the left and right channels. It is also within the scope of the invention that a single audio signal be transmitted via a single modulated carrier signal, and/or that multiple audio signals or signal components be transmitted via a single modulated carrier signal. Accordingly, one audio signal may correspond to two or more modulated carrier signals 22; one audio signal may correspond to only a single modulated carrier signal 22; or multiple audio signals may correspond to a single modulated carrier signal 22. Embodiments illustrating certain of these modes of operation will be discussed below.

As indicated above, automobile entertainment system 10 is configured to operate with multiple audio source devices 16 and transmit modulated carrier data 18 corresponding to multiple audio signals produced by those devices. The information relating to the audio signals typically is embedded within multiple modulated carrier signals 22, which are simultaneously wirelessly transmitted within the automobile by transmitter 14 so that the modulated carrier signals are available for reception within the automobile. This permits use of a receiver 20 to receive and selectively process the transmitted information to obtain a recovered output signal for delivery to an occupant of automobile 12. The recovered output signal typically is based on a selected one of the audio signals produced by source devices 16 that the occupant wants to listen to. Use of multiple receivers 20 allows the receivers to operate independently to obtain different desired audio signals from modulated carrier data 18.

Specifically, as shown in FIG. 1, automobile audio system 10 may include one or more receivers 20 configured for use within automobile 12. Receivers 20 may be selectively tuned so as to control how they receive and/or process modulated carrier data 18 transmitted by transmitter 14. Specifically, tuning a particular receiver controls which audio signal is recovered from modulated carrier data 18 and delivered as output to a user. Assuming audio signals provided from CD player 16a and DVD/VCP player 16e, one tuning would cause the receiver to recover and output the audio signal from the CD player, while a second tuning would cause recovery and output of the audio signal from the DVD/VCP player. If two receivers were used, one could be tuned to the CD player output, while the other was tuned to the DVD/VCP player output.

Automobile audio system 10, and the other embodiments thereof which will be described below, may be configured for aftermarket installation in an automobile or, alternatively, provided as an integrated part of a unified system. In particular, transmitter 14 may be installed into an automobile in an aftermarket procedure, in which the transmitter is coupled with audio source devices already installed in the vehicle. Typically, the audio source devices and transmitter are coupled via a wired, as opposed to a wireless, connection, though wireless coupling may be used. Transmitter 14 may be installed into, behind or underneath the dashboard or instrument panel, or positioned in any other convenient location. Instead of being an aftermarket device, the transmitter may alternatively be incorporated with one or more audio source devices into a unified system. In such a case, the audio source devices and transmitter comprise an integral audio system that is installed as a collective unit or assembly within the automobile. In either case, receivers 20 typically are separate from the transmitter and audio source devices and operable from a location remote from these components.

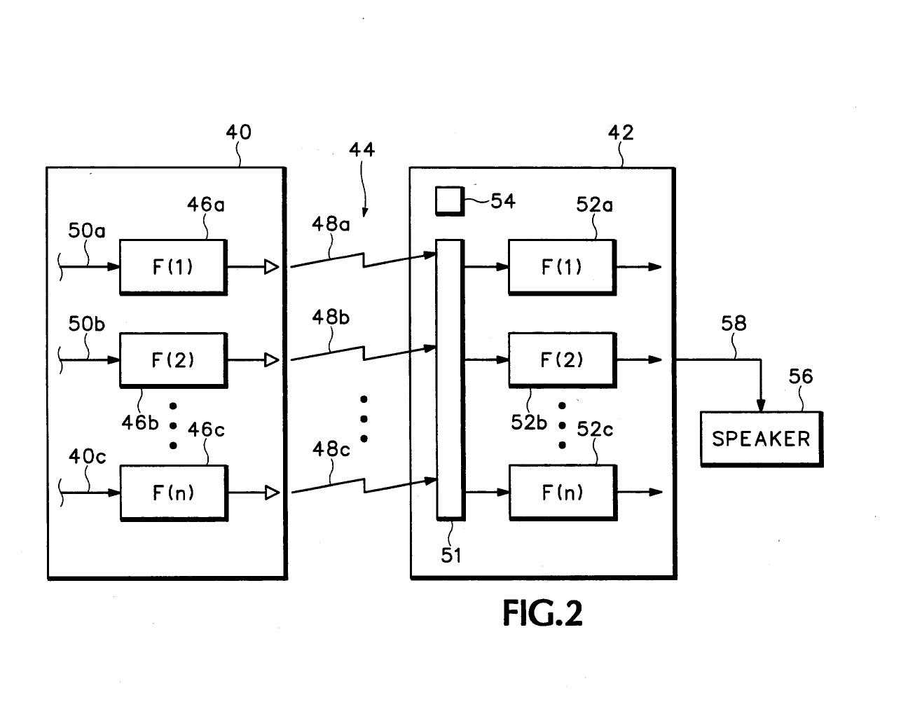

FIG. 2 schematically depicts embodiments of a transmitter 40 and receiver 42 according to the present invention. Similar to the system discussed with reference to FIG. 1, transmitter 40 and 42 receiver are wirelessly coupled, such that modulated carrier data 44 wirelessly transmitted by transmitter 40 is receivable by receiver 42. Preferably, the transmitter and receiver are configured so that both transmission and reception occurs within an automobile.

Transmitter 42 includes a number of modulator sections 46 which operate at carrier frequencies F(1), F(2) . . . F(n). Each modulator is configured to generate a modulated carrier signal 48 based on an input 50 and an unmodulated carrier signal of the respective carrier frequency (F(1), F(2), etc . . . ). Specifically, some characteristic of the unmodulated carrier signal is varied in proportion to some characteristic of the input signal 50. For example, referring specifically to modulated carrier signal 48a, the modulated carrier signal may be generated by varying the amplitude, phase, or frequency of an unmodulated carrier signal having frequency F(1) in proportion to the instantaneous level of input 50a.

Receiver 42 receives modulated carrier data 44 via a receiving device 51, such as an antenna, which is coupled with a number of demodulator sections 52. Demodulator sections 52 are configured to perform demodulation operations on modulated carrier data 44 at the frequencies used by transmitter 40: F(1), F(2) . . . F(n). The output signal ultimately provided by receiver 42 for delivery to a user is selected through operation of a user-actuable selector 54. The selected output is in the form of a recovered audio signal, which is an exact or least approximate reproduction of the input audio signal applied to one or more of the modulator sections 46. The recovered audio signal may then be provided to a speaker 56 or like output device.

Depending on the input(s) to a given modulator section 46, the resulting modulated carrier signal 48 will vary in its correspondence to an audio signal or signals produced by an audio source device. The depicted system may be configured to operate so that the input to a given modulator section 46 is but one component of a multi-component audio signal. For example, input 50a may be the left channel of the stereo audio signal produced by CD player 16a shown in FIG. 1. Assume further that the right channel is supplied as input 50b to modulator 46b. In such a case, modulated carrier 48a would be generated using the left channel of the stereo audio signal and an unmodulated carrier having frequency F(1), and modulated carrier 48b would be generated using the left channel and an unmodulated carrier signal having frequency F(2). The resulting modulated carrier signals 48a and 48b, taken collectively, would correspond to the stereo audio signal produced by CD player 16a. The stereo audio signal would be recoverable at receiver 42 by tuning the receiver to process the modulated carrier data at both of the employed carrier frequencies F(1) and F(2) (e.g., via demodulation operations occurring in demodulator units 52a and 52b).

The input to a given modulator section 46 may be an entire audio signal or multiple audio signals, instead of just individual components of an audio signal. For example, input 50a may be the output audio signal from AM radio 16d, which is a mono, single channel audio signal. In this example, modulated carrier signal 48a would correspond to the AM radio audio signal, and would be generated using that audio signal together with an unmodulated carrier signal of frequency F(1). The AM radio audio signal would be recovered via demodulation with the demodulator section configured for operation at frequency F(1) (i.e., demodulator section 52a).

A stereo signal may also serve as an input to an individual one of modulator sections 46, in contrast to the previous example where the left and right channels were supplied to separate modulator sections 46. This may be accomplished by multiplexing left and right channels of the stereo signal together, using time-division multiplexing or a like scheme for combining signal components. In addition to combining components of a single signal, multiplexing may be used to combine two or more audio signals into a single input (e.g., one of inputs 50) so that they may be applied to an individual one of modulator sections 46. Multiplexing will be described in further detail with reference to FIG. 4.

As indicated above, receiver 42 receives and processes modulated carrier data 44 so as to recover the audio signals applied as inputs to modulator sections 46 of transmitter 40. Receiver 42 may be configured to be selectively tunable to control which of the input audio signals is recovered and delivered by receiver 42 as output for audible delivery to a user. Typically, this is accomplished through operation of selector 54, which is included on receiver 42. The user operates selector 54 according to his or her preference of a particular one of the various audio signals applied to transmitter 40. Tuning through use of selector 54 causes the receiver to output a recovered reproduction of the desired audio signal on output line 58. As indicated, a speaker 56 or other output device may be provided to output the recovered audio signal in audible form.

Selector 54 may be configured to operate in various ways. In one configuration, selector 54 acts as a two-way A/B switch (or three, four or n-way switch, depending on the number of recoverable audio signals contained within modulated carrier data 44) that performs switching upstream of demodulator sections 52. This selectively delivers the received modulated carrier data (or a selected portion thereof) to the demodulator section(s) needed to recover the desired audio signal. In this configuration, typically there is no signal applied to the unused demodulator sections. Filtering and other processing operations may be performed prior to demodulation of the modulated carrier data.

Alternatively, or in addition to the above-described operation, operation of selector 54 may affect processing downstream of demodulator sections 52. For example, the modulated carrier data may be applied to all of demodulator sections 52, with each particular section demodulating its respective portion of the modulated data and outputting a corresponding recovered signal. In this configuration, operation of selector 54 causes a selected one of the various recovered signals to be delivered via output line 58, based on the desired audio signal to be recovered. In other words, the switching/selection operation occurs after demodulation of the various modulated carrier signals 48.

Operation of selector 54 will also vary depending on the correspondence between modulated carrier data 44 and the transmitted audio signals. For example, if multiple modulated carrier signals 48 are used to carry a single audio signal (e.g., a modulated carrier signal for each of a left and right component of a stereo signal), then tuning receiver 42 to recover the audio signal involves tuning the receiver to process two or more modulated carrier signals using multiple demodulator sections 52. On the other hand, where a single modulated carrier signal 48 is involved, only one of demodulator sections 52 is needed. In either case, additional processing may be necessary or desired downstream of demodulator sections 52.

Transmitter 40 and receiver 42 may be configured to operate using a variety of modulation schemes. Frequency modulation has proven particularly useful. In addition, the employed carrier frequencies and modulation techniques typically are selected so as to minimize interference between the modulated carrier signals and ensure adequate reproduction of the audio signals upon demodulation and subsequent processing.

As discussed above with reference to FIG. 1, multiple receivers similar to receiver 42 may be employed for use with transmitter 40 in an automobile entertainment system according to the present invention. The receivers typically are independent of one another, allowing each to be tuned to recover a different one of several available audio signals. As seen in FIG. 2, a speaker 56 or other output device may be provided in connection with a receiver according to the present invention. Often it will be desirable that the speaker or output device be capable of providing audible output localized to a relatively small or bounded area within an automobile. This allows one occupant to listen to a particular audio source without disturbing other occupants of the automobile.

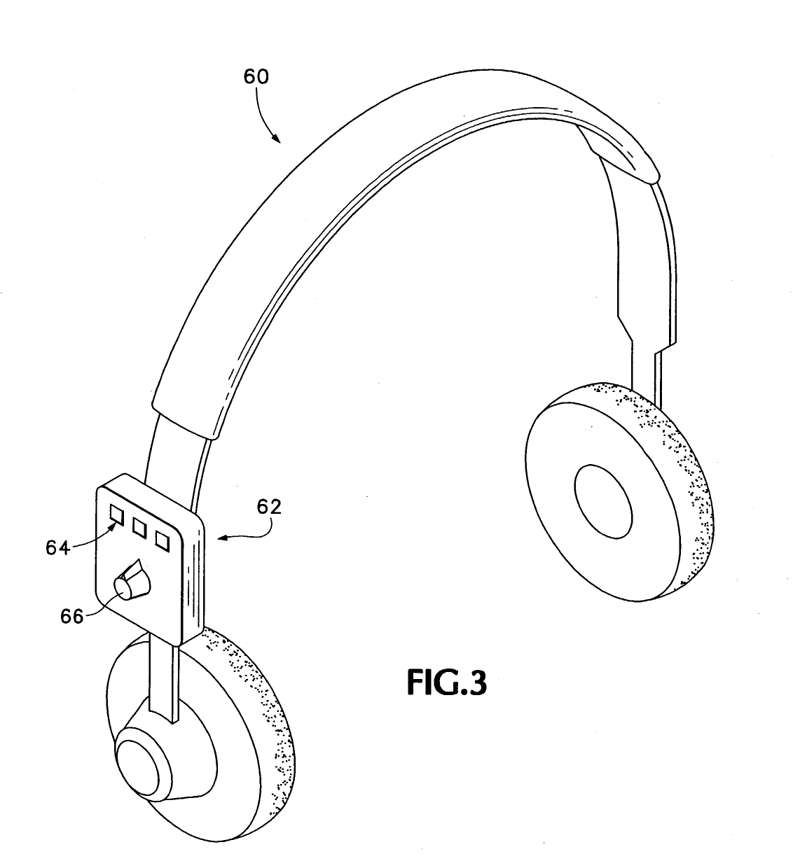

FIG. 3 depicts a headphone unit 60 according to the present invention which is capable of providing such localized audio output. A receiver 62, similar to that previously described, is mounted on or otherwise associated with the pair of headphones 60. Receiver 62 and headphones 60 typically are wireless devices which can be used in any location proximal to the previously described transmitters. Normally, receiver 62 and headphones 60 have an operational range at least large enough to permit reception and recovery of desired signals at any location within an automobile in which a transmitter according to the present invention is employed. Receiver 62 may be provided with various controls 64, including volume controls, tone controls, etc. Typically, receiver 62 also includes a selector switch 66 positioned in a location accessible to the wearer of the headphones. Though shown as a knob, selector switch 66 may be implemented to include one or more buttons, touch sensing devices, and/or any other suitable switching device capable of being operated by the wearer of the headphones. Operation of selector switch 66 effects the tuning function described with reference to FIG. 2, allowing the wearer of the headphones to recover and listen to a particular desired audio signal outputted by audio source devices 16 (FIG. 1). Where two or more pairs of headphone units 60 are provided in connection with associated receivers 62, different users may tune in and listen to different audio signals without disturbing each other, or other occupants who choose not to listen to any audio source. This provides each individual user with all the features and functionality of the main audio system of the automobile, without forcing all occupants of the vehicle to listen to the same audio source. The depicted headphones and their various features may be used in connection with any of the receiver embodiments described herein.

FIG. 4 schematically depicts further embodiments of a transmitter 70 and receiver 72 according to the present invention. The depicted transmitter is configured to receive and multiplex left and right channels of a stereo audio signal into a multiplexed signal. This multiplexed signal is then used by transmitter 70 to generate and wirelessly transmit a modulated carrier signal within the automobile so that it may be received and processed by receiver 72.

As indicated, transmitter 70 includes two modulator sections 74 configured to generate modulated carrier signals based on input multiplexed signals 76 and unmodulated carrier signals of frequencies F(1) and F(2), respectively. The input of each modulator section is fed by a multiplexer 78 configured to multiplex left and right channels 80 and 82 of a stereo audio signal 84 into a single multiplexed signal 76, which is applied as an input to the respective modulator section. Typically, multiplexers 78 combine the left and right channels via time-division multiplexing or a like scheme. Once the signal components are multiplexed, modulator sections 74 generate modulated carrier signals 86 based on the multiplexed input signals and unmodulated carrier signals. A wide variety of carrier frequencies may be used for the unmodulated carrier signals. Radio frequencies of F(1)=912.5 MHz and F(2)=914 Mhz will be suitable for many applications.

For each of frequencies F(1) and F(2), receiver 72 includes a demodulator section 88, which is coupled to and receives input from receiving device 90. As indicated, each demodulator section 88 may include a local oscillator 92, mixer 94, and filter 96. Where F(1)=912.5 MHz, local oscillator 92a of demodulator 88a typically will be 902.8 MHz, such that the output of mixer 94a is centered about 10.7 MHz. Filter 96a pulls this signal down to 455 KHz. Resulting output 98a provided from demodulator section 88a is a recovered version of multiplexed input 76a applied to F(1) modulator section 74a. Similarly, where F(2)=914 MHz, local oscillator 92b of demodulator 88b typically will be 903.7 MHz, such that the output of mixer 94b is also centered about 10.7 MHz. Filter 96b pulls this signal down to 455 KHz. This output (i.e., output 98b) is a recovered version of multiplexed input 76b applied to F(2) modulator section 74b. Demultiplexers 100 separate the left and right channels of the recovered signals. After any subsequent processing (e.g., filtering, signal processing, etc), the desired stereo output signal 102 or 104 is supplied to left and right speakers 106 and 108.

As with the previously described receiver embodiments, receiver 72 includes a user-actuable selector 110. Operation of selector 110 causes a desired one of output stereo audio signals 102 and 104 to be output by receiver 72. The switching operation controlled by selector 110 may occur upstream and/or downstream of demodulator sections 88 (i.e., before or after the demodulation occurs).

When transmitter 70 and receiver 72 are employed in a setting such as that depicted in FIG. 1, one of stereo signals 84a and 84b received by transmitter 70 typically will be audio output from the car stereo system (i.e. system 24). The other input audio signal often will be a stereo signal received from DVD/VCP player 16e. Multiple receivers 72 may then be employed in connection with headphones such as those shown in FIG. 3, to allow listeners to selectively tune to receive audio from either car stereo 24 (i.e., CD player 16a, FM radio 16c, etc.) or DVD/VCP player 16e.

FIG. 5 depicts additional embodiments of a transmitter 120 and receiver 122 which may be used in connection with an automobile audio system according to the present invention. As with the components shown in FIG. 4, the depicted transmitter and receiver are configured to transmit, receive and process wireless communications associated with two stereo audio signals (i.e., stereo audio signals 124). However, instead of multiplexing, the left and right channels 126 and 128 of the input stereo audio signals are individually applied to modulator sections 130, 132, 134 and 136, which respectively operate at frequencies F(1), F(2), F(3) and F(4). Thus, modulator sections 130 and 132 generate a modulated carrier signal pair (signals 140 and 142) that corresponds to stereo audio signal 124a. Stereo audio signal 124a is recovered via demodulation occurring in receiver 122 at demodulator sections 144 and 146. Similarly, modulator sections 134 and 136 generate a second pair of modulated carrier signals (signals 148 and 150). This second pair corresponds to stereo audio signal 124b, which may be recovered in the receiver via demodulation with demodulator sections 152 and 154.

Similar to the previously described receivers, receiver 122 includes a receiving device 160 for receiving the modulated carrier data transmitted by transmitter 120. Receiver 122 also includes a selector 162, similar to the previously described embodiments, which is configured to cause receiver 122 to recover and output a desired one stereo audio signals 124a and 124b to speakers 164 and 166.

Many different frequency ranges may be used to accomplish modulation with the system depicted in FIG. 5. For example, as with the components shown in FIG. 4, radio frequency carriers may be used. For other applications, infrared frequencies will be appropriate. For IR-based modulation, the following frequencies have been found suitable for use with the modulator and demodulator sections depicted in FIG. 5: F(1)=2.3 GHz, F(2)=2.8 GHz, F(3)=3.2 GHz, and F(4)=3.6 GHz. Infrared carrier frequencies may also be used for any of the other transmitter and receiver embodiments described herein.

As explained above, FIGS. 4 and 5 both depict systems configured to wirelessly transmit and receive modulated carrier data associated with two input audio signals. It should be understood, however, that these systems may be modified for use with three, four or more audio signals. In addition, any desired number of receivers may be used with the various systems depicted and described herein.

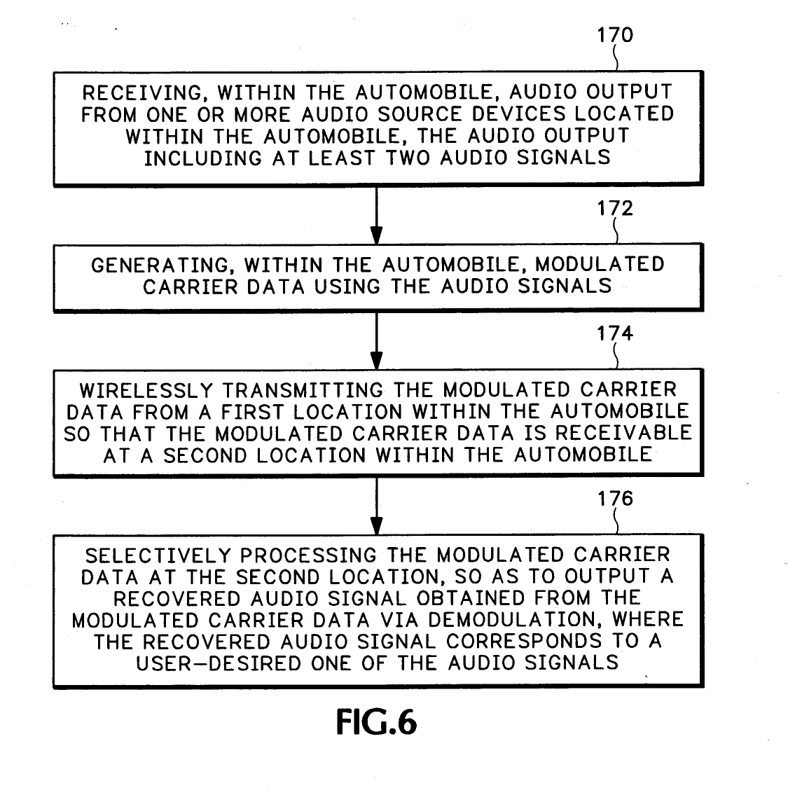

From the above, it should be appreciated that the invention also includes a method of delivering audio that allows different occupants of an automobile to simultaneously and selectively listen to audio output from different audio source devices that are located within the automobile. FIG. 6 depicts such a method. As indicated at 170, the method includes receiving, within the automobile, audio output from one or more audio source devices located within the automobile, where the audio output includes at least two audio signals. At 172, the method includes generating, within the automobile, modulated carrier data using the audio signals. At 174, the method includes wirelessly transmitting the modulated carrier data from a first location within the automobile so that the modulated carrier data is receivable at a second location within the automobile. As discussed above with reference to FIGS. 1-5, steps 170, 172 and 174 may be accomplished using a transmitting device mounted within the automobile and coupled to various audio devices located in the automobile.

At 176, the method includes selectively processing the modulated carrier data transmitted at step 174 at the second location within the automobile. Typically, this second location is spaced from the transmitting location, as is the case where a headphone receiver unit such as that shown in FIG. 3 is used in the backseat of an automobile having a dashboard-installed transmitter unit. The selective processing of the modulated carrier data is performed using demodulation so as to output a recovered audio signal which corresponds to a user desired one of the audio signals received at step 170.

The method described above may include any of the functions and features of the devices described above with reference to FIGS. 1-5. For example, generating the modulated carrier data (i.e., step 172) may include multiplexing left and right channels of a stereo input signal to produce a multiplexed signal, which is then used to generate an individual modulated carrier signal. Alternatively, or additionally, the left and right channels of a stereo signal may be used to generate separate modulated carrier signals, as discussed with reference to the transmitter and receiver embodiments shown in FIG. 5. In addition, as variously discussed in connection FIGS. 1-5, selective processing of the modulated carrier data may occur simultaneously and independently at a number of locations within the automobile. This allows different users to recover different desired the audio signals from the modulated carrier data.

While the present invention has been particularly shown and described with reference to the foregoing preferred embodiments, those skilled in the art will understand that many variations may be made therein without departing from the spirit and scope of the invention as defined in the following claims. The description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

We claim:

1. An automobile audio system, comprising:
a transmitter configured for installation within an automobile and further configured to wirelessly transmit modulated carrier data so that the modulated carrier data is receivable within the automobile, the modulated carrier data being associated with at least two audio signals which are used to generate the modulated carrier data; and
a receiver configured for use within the automobile, where the receiver is selectively tunable to output a recovered audio signal, which is an at least approximate reproduction of a user-desired one of the audio signals, the receiver being further configured to obtain the recovered audio signal from the modulated carrier data via demodulation.

2. The automobile audio system of claim 1, where the receiver is configured to obtain the recovered audio signal by demodulating only a selected portion of the modulated carrier data, the selected portion being selected via tuning of the receiver.

3. The automobile audio system of claim 2, where the selected portion of the modulated carrier data includes first and second modulated carrier signals, which respectively are generated by the transmitter using left and right channels of a stereo audio signal.

4. The automobile audio system of claim 2, where the transmitter is configured to multiplex left and right channels of a stereo audio signal into a multiplexed audio signal and generate a modulated carrier signal based on the multiplexed audio signal, and where the selected portion of the modulated carrier data includes the modulated carrier signal.

5. The automobile audio system of claim 1, where the transmitter is configured to use left and right channels of a stereo audio signal to respectively generate first and second modulated carrier signals, the transmitter being further configured to transmit the first and second modulated carrier signals as part of the modulated carrier data.

6. The automobile audio system of claim 1, where the transmitter is configured to multiplex left and right partial signals of a stereo audio signal into a multiplexed audio signal and generate a modulated carrier signal using the multiplexed audio signal, the transmitter being further configured to transmit the modulated carrier signal as part of the modulated carrier data.

7. The automobile audio system of claim 6, where the transmitter is configured to multiplex the left and right partial signals using time division multiplexing.

8. The automobile audio system of claim 1, where the receiver includes a user-actuable selector configured to selectively tune the receiver to output the recovered audio signal.

9. The automobile audio system of claim 8, where the receiver is coupled with and configured to output the recovered audio signal to a pair of wireless headphones.

10. The automobile audio system of claim 9, where the user-actuable selector includes a switch mounted on the pair of wireless headphones.

11. The automobile audio system of claim 1, where the modulated carrier data includes modulated carrier signals generated using different carrier frequencies, to inhibit interference between the modulated carrier signals.

12. The automobile audio system of claim 1, where the transmitter is configured to receive audio output from an automobile stereo unit located within the automobile and audio output from a video player located within the automobile, and where one portion of the modulated carrier data corresponds to the audio output from the automobile stereo unit and another portion of the modulated carrier data corresponds to the audio output from the video player.

13. The automobile audio system of claim 1, where the receiver is one of a plurality of receivers, each receiver being independently tunable to enable different receivers to output different recovered audio signals at at least approximately the same time.

14. The automobile audio system of claim 1, where the modulated carrier data includes modulated carrier signals that are modulated and wirelessly transmitted using radio frequency carriers.

15. The automobile audio system of claim 1, where the modulated carrier data includes modulated carrier signals that are modulated and wirelessly transmitted using infrared frequency carriers.

16. An automobile audio system, comprising:
a transmitter configured to be installed within an automobile and coupled with at least two audio source devices provided within the automobile, the transmitter being further configured to:
receive at least two audio signals from the audio source devices;
generate modulated carrier data based on the audio signals; and
wirelessly transmit the modulated carrier data so that the modulated carrier data is available for reception within the automobile, the transmitter being further configured to transmit the modulated carrier data so as to permit selective recovery within the automobile of any of the audio signals from the modulated carrier data via demodulation.

17. The automobile audio system of claim 16, further comprising a receiver configured for use within the automobile, the receiver being selectively tunable to cause a user-desired one of the audio signals to be recovered from the modulated carrier data via demodulation.

18. The automobile audio system of claim 17, where the receiver is configured to recover the user-desired one of the audio signals by demodulating only a selected portion of the modulated carrier data, the selected portion being selected via tuning of the receiver.

19. The automobile audio system of claim 18, where the selected portion of the modulated carrier data includes first and second modulated carrier signals, which respectively are generated by the transmitter using left and right channels of a stereo audio signal.

20. The automobile audio system of claim 18, where the transmitter is configured to multiplex left and right channels of a stereo audio signal into a multiplexed audio signal and generate a modulated carrier signal based on the multiplexed audio signal, and where the selected portion of the modulated carrier data includes the modulated carrier signal.

21. The automobile audio system of claim 17, where the receiver includes a user-actuable selector configured to selectively tune the receiver to cause the user-desired one of the audio signals to be recovered from the modulated carrier data.

22. The automobile audio system of claim 21, where the receiver is coupled with and configured to provide audio output to a pair of wireless headphones.

23. The automobile audio system of claim 22, where the user-actuable selector includes a switch mounted on the pair of wireless headphones.

24. The automobile audio system of claim 17, where the receiver is one of a plurality of receivers, each receiver being independently tunable to enable different receivers to recover different desired audio signals from the modulated carrier data at at least approximately the same time.

25. The automobile audio system of claim 16, where the transmitter is configured to use left and right channels of a stereo audio signal to respectively generate first and second modulated carrier signals, the transmitter being further configured to transmit the first and second modulated carrier signals as part of the modulated carrier data.

26. The automobile audio system of claim 16, where the transmitter is configured to multiplex left and right channels of a stereo audio signal into a multiplexed audio signal and generate a modulated carrier signal using the multiplexed audio signal, the transmitter being further configured to transmit the modulated carrier signal as part of the modulated carrier data.

27. The automobile audio system of claim 26, where the transmitter is configured to multiplex the left and right partial signals using time division multiplexing.

28. The automobile audio system of claim 16, where the modulated carrier data includes modulated carrier signals generated using different carrier frequencies, to inhibit interference between the modulated carrier signals.

29. The automobile audio system of claim 16, where the transmitter is configured to receive audio output from an automobile stereo unit located within the automobile and audio output from a video player located within the automobile, and where one portion of the modulated carrier data corresponds to the audio output from the automobile stereo unit and another portion of the modulated carrier data corresponds to the audio output from the video player.

30. The automobile audio system of claim 16, where the modulated carrier data includes modulated carrier signals that are modulated and wirelessly transmitted using radio frequency carriers.

31. The automobile audio system of claim 16, where the modulated carrier data includes modulated carrier signals that are modulated and wirelessly transmitted using infrared frequency carriers.

32. An audio delivery method for permitting different occupants of an automobile to simultaneously and selectively listen to audio output from different audio source devices provided within the automobile, comprising:
receiving, within the automobile, audio output from one or more audio source devices located within the automobile, the audio output including at least two audio signals;
generating, within the automobile, modulated carrier data using the audio signals;
wirelessly transmitting the modulated carrier data from a first location within the automobile so that the modulated carrier data is receivable at a second location within the automobile; and
selectively processing the modulated carrier data at the second location, so as to output a recovered audio signal obtained from the modulated carrier data via demodulation, where the recovered audio signal corresponds to a user-desired one of the audio signals.

33. The audio delivery method of claim 32, where the audio signals include a stereo audio signal, and where generating the modulated carrier data includes:
multiplexing left and right channels of the stereo audio signal into a multiplexed audio signal; and
producing a modulated carrier signal using the multiplexed audio signal.

34. The audio delivery method of claim 32, where the audio signals include a stereo audio signal, and where generating the modulated carrier data includes generating first and second modulated carrier signals using left and right channels of stereo audio signal, respectively.

35. The audio delivery method of claim 32, where selectively processing the modulated carrier data occurs simultaneously and independently at a plurality of locations within the automobile, permitting different recovered audio signals to be simultaneously obtained from the modulated carrier data at different locations within the automobile.
